(19) United States
(12) Patent Application Publication
(10) Pub. No.: US 2024/0227110 A1
(43) Pub. Date: Jul. 11, 2024

(54) METHOD FOR TREATING A SURFACE OF A PISTON ROD

(71) Applicant: SAFRAN LANDING SYSTEMS, Velizy-Villacoublay (FR)

(72) Inventors: Gilles AUREGAN, MOISSY CRAMAYEL (FR); Aurélie SOULA, MOISSY CRAMAYEL (FR)

(21) Appl. No.: 18/562,094

(22) PCT Filed: May 11, 2022
(86) PCT No.: PCT/FR2022/050900

§ 371 Date: Nov. 17, 2023

(30) Foreign Application Priority Data
May 20, 2021 (FR) FR2105265

(51) Int. Cl. B24B 19/00; F16D 65/18; F16D 121/04; F16D 125/06; F16D 125/08

(52) U.S. Cl. CPC B24B 19/00; F16D 65/18; F16D 2121/04; F16D 2125/06; F16D 2125/08; F16D 2250/0038

(57) ABSTRACT

A method for treating a surface of a rod of a piston, the rod being made of high mechanical strength alloy with a minimum hardness above 45 HRC, includes a grinding procedure, and a polishing procedure performed until a mean roughness Ra≤0.2 μm is obtained. This results in a surface finish allowing the dynamic sealing requirements of the piston to be maintained without requiring chrome plating.

### TECHNICAL FIELD OF THE INVENTION

The technical field of the invention is that of the surface treatment of mechanical parts such as piston rods and the rods obtained.

This invention in particular relates to piston rods equipping braking systems for aircraft landing gear.

### TECHNOLOGICAL BACKGROUND OF THE INVENTION

Pistons used in braking systems compress an assembly of discs fitted in the wheel and to the axle. This assembly, referred to as a heat sink, is made up of stators integral with the axle and rotors integral with the wheel. Compression of the discs slows down the relative rotational movement between the rotors and stators. Pistons to which the present invention refers are hydraulic pistons, moved by hydraulic fluid under pressure.

The pistons are directly screwed into a ring integral with the braking system and should fulfil the following main functions:
apply the pressure force to the heat sink,
automatically compensate for wear on the heat sink,
return the piston to prevent residual braking in the braking system,
provide the sealing function.
   The rod is one of the major components of the piston. It contributes to the heat sink wear compensation function by gradually deforming a deformation tube by virtue of a sphere screwed to its end.

The rod should have sufficient mechanical properties to withstand loads required to deform the deformation tube on the one hand and to withstand pre-stressing forces associated with tightening the sphere on the other hand.

The rod should also fulfil a sealing function between the pressurised environment, on the hydraulic fluid side, and the non-pressurised environment, on the brake disc side, by means of a rod seal. The rod requires a specific roughness in order to limit wear of the seal while promoting slipping thereof, and sufficient hardness to avoid impairment of this roughness by friction against the seal. The seal can be made of a single-piece elastomer or in several parts: for example, an elastomer seal with a harder PTFE (polytetrafluoroethylene) part.

At present, these rods are made of stainless steel, for example type 15-5PH, which has the necessary mechanical properties to ensure the wear compensation function.

The body of the rod interfacing with the seal is coated with a hard chromium deposit. This deposit is ground to obtain the appropriate roughness for the sealing function, and its high hardness enables it to withstand friction against the rod seal.

However, this technical solution poses several problems:
The hard chromium deposit may have porosity that could promote hydraulic leakage.
The chromium plating and grinding range is complex and expensive,
The chromium plating range does not meet environmental requirements.

A 15-5PH stainless steel rod solution, ground and without hard chrome, also exists with other aeronautical brake suppliers, but this solution is not applicable for rod seals which require a minimum surface hardness of the rod greater than 45 HRC, that is a seal in two parts: elastomer and PTFE.

### SUMMARY OF THE INVENTION

The invention offers a solution to the problems discussed above, by making it simpler to produce rods which provide a satisfactory seal and do not require additional surface treatment.

A material is thus used which has both the mechanical properties required to compensate for wear (Rm>1100 MPa), and the ability to be machined and ground to achieve a roughness satisfactory for the sealing function (Ra value<0.2 μm, defined limit), under the strain conditions described above and specific to the application, and also sufficient hardness to withstand friction with the seal and guarantee integrity of the surface finish (<45 HRC).

One aspect of the invention relates to a method for treating surface of a piston rod, the rod being made of a high-strength alloy, characterised in that it comprises the following steps:

a grinding step and,

a finishing step until an average roughness Ra≤0.2 μm is obtained.

Advantageously, the average roughness Ra≤0.1 μm.

In this way, a surface finish is obtained which enables dynamic sealing requirements of the piston to be met without the need for chromium plating. For example, a maximum height Rp≤0.4 μm and a maximum deviation Rz≤2.0 μm may be obtained.

Advantageously, the alloy has a minimum hardness greater than 45 HRC. This allows a greater variety of seals to be used. The alloy may be a metal alloy.

Advantageously, the alloy is a nickel-based superalloy. For example, an IN718 type alloy may be used.

Advantageously, the alloy has a tensile strength Rm>1100 MPa. This strength enables the rod to deform the deformation tube.

The final roughness can be obtained in two ways: with grinding followed by superfinishing by mechanical polishing (disc abrasion), or with grinding followed by finishing by tribofinishing.

Advantageously, the finishing step is tribofinishing. This technique makes it possible to obtain the desired level of roughness. Tribofinishing gathers all the industrial abrasion machining methods used to improve roughness (by abrasion, shearing or impact) by moving abrasive media about a part in a tank. Examples include tumbling, linear and circular vibrators, centrifugal force machines, drag finishing or surface finishing.

A first aspect of the invention relates to a piston rod obtained by the surface treatment method according to one of the preceding characteristics.

A second aspect of the invention relates to a piston comprising a piston rod obtained by the method according to the invention.

Advantageously, the piston rod comprises a seal between a pressurised environment and a non-pressurised environment. The surface characteristics of the rod make it possible to limit wear of the seal and to guarantee proper sealing despite the pressure difference in the case of dry pistons.

Advantageously, the rod is disposed in a deformation tube and comprises a sphere at a first end cooperating with the deformation tube. The rod is sufficiently rigid to withstand the loads required to deform the deformation tube on the one hand and to withstand the prestressing forces associated with mounting the nut and sphere on the other hand.

A third aspect of the invention relates to a braking system comprising at least one piston according to the invention.

The invention and its different applications will be better understood upon reading the following description and upon examining the accompanying figures.

### BRIEF DESCRIPTION

The figures are set forth by way of indicating and in no way limiting purposes of the invention.

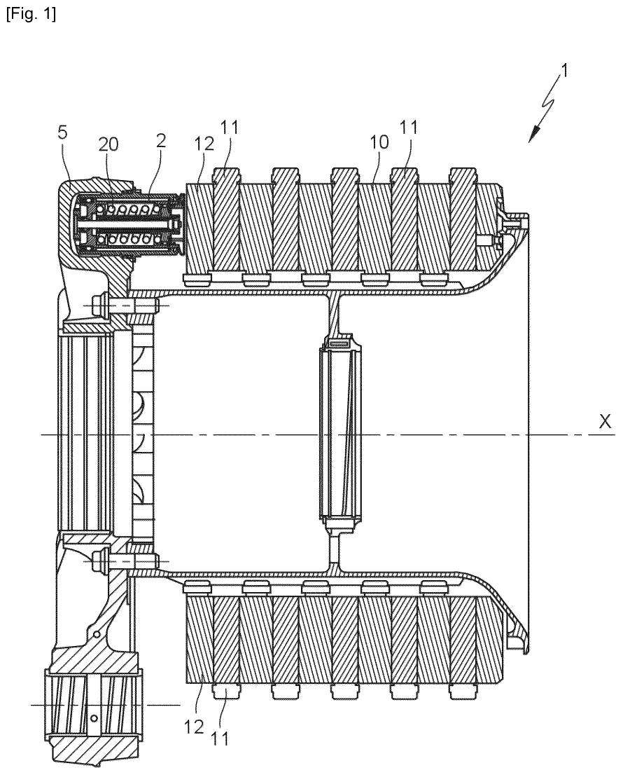

FIG. 1 is a cross-section view of a braking system of an aircraft landing gear,

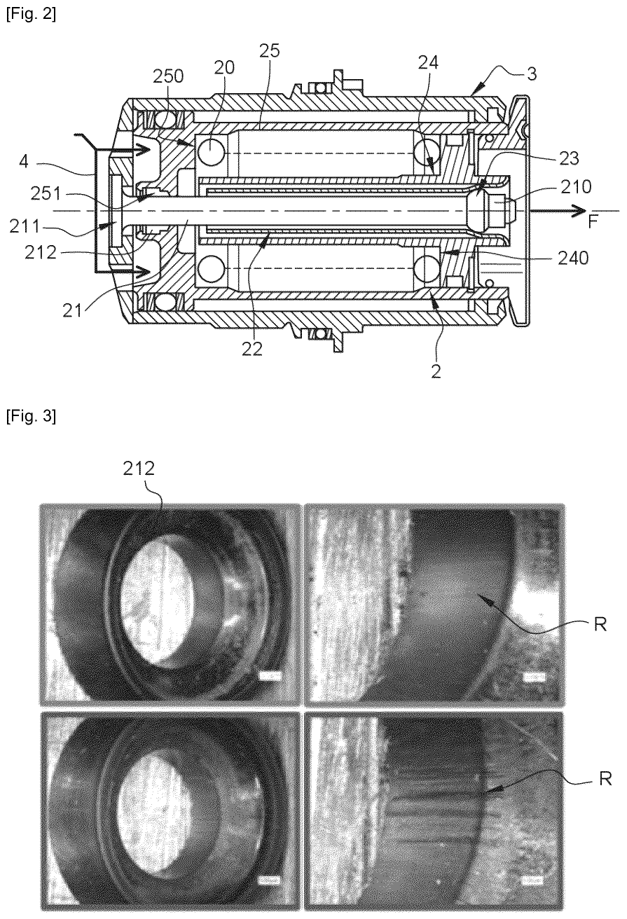

FIG. 2 shows the detail of a piston equipping the braking system of FIG. 1,

FIG. 3 shows the wear of a piston seal of FIG. 2,

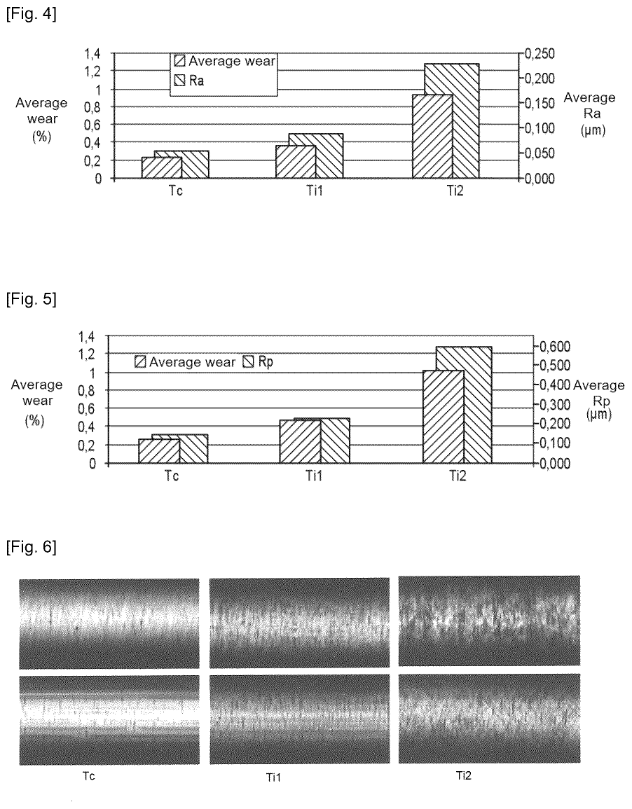

FIG. 4 is a table showing the results of wear tests as a function of the average roughness Ra of the rod surface,

FIG. 5 is a table showing the results of wear tests as a function of the roughness parameter Rp of the rod surface,

FIG. 6 shows the appearance of the rod before and after the tests with different roughnesses,

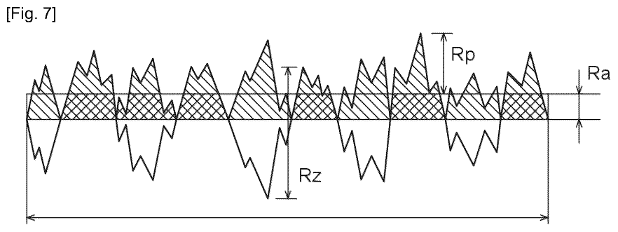

FIG. 7 represents the different roughness parameters.

### DETAILED DESCRIPTION

Unless otherwise specified, a same element appearing in different figures has a single reference.

The braking system 1 illustrated in FIG. 1 is intended for an aeronautical landing gear. It consists of a ring 5 and several brake discs stacked one on top of the other, forming what is known as a “heat sink” because of the temperature they can reach. Half of these discs are integral with the wheel (or rim) of axis X and rotate with it, these are the rotor discs 11; the other half are integral with the aeroplane via the axle and do not rotate, these are the stator discs 10, 12. They are mounted alternately, to form an assembly known as a heat sink. It is the friction between the discs that ensures braking.

The first disc 12 on which pistons 2 act (only one represented) is a stator disc integral with the axle. When the brakes are released, the piston 2 extends out of the sleeve 3 under the effect of hydraulic pressure and compresses the heat sink. When the pressure is released, a spring 20 pushes the piston 2 back into the sleeve 3.

The piston 2 comprises a hollow body 25 and includes a guide 24 which holds the spring 20 between two bearing surfaces: a first surface 240 integral with the guide 24 and a second surface 250 integral with the hollow body 25.

The piston 2 also comprises a rod 21 which serves as an automatic brake wear adjustment device. The rod 21 is placed in a deformation tube 22 and comprises at a first end 210 a sphere 23 whose diameter is greater than the diameter of the deformation tube 22. As the brake discs wear, the sphere 23 will move back, deforming the deformation tube 22 and thus displacing the piston stroke to compensate for wear. The distance between the stator discs 11 and the rotor discs 10, 12 is thus maintained at a constant minimum by the displacement of the sphere 23 in the deformation tube 22 and makes it possible to ensure a same brake pedal clearance whatever the wear of the discs.

The piston 2 operates as follows: a hydraulic fluid 4, such as oil, arrives at one side of the piston 2 and pushes it through the force F to bring it into contact with the first stator disc 12 until the stator discs 12, 10 and the rotor discs 11 are in contact. If the discs are worn, piston 2 will advance further and rod 21 will move back in the deformation tube 22, extending stroke of the piston 2 by the thickness of the disc wear. When the brakes are released, the piston 2 is pushed back by the spring 20 placed on the opposite side to the hydraulic fluid 4 inlet.

The rod 21 is connected via a second end 211 to the ring 5 of the braking system 1. The rod 21 thus passes through the second surface 250 of the hollow body 25 via a hole 251. This hole 251 is equipped with a seal 212 which guarantees sealing around the rod 21 between the hydraulic fluid 4 under pressure and the outside at atmospheric pressure. When the piston 4 moves, the seal 212 will slide on the rod 4, which can cause degradation of the seal 212 if the surface of the rod 21 does not have sufficient surface, hardness and roughness conditions.

Two examples of wear on the seal 212 where scratches R are visible can thus be seen in FIG. 3. The surface finish required to meet dynamic sealing requirements is therefore of prime importance. Hence, current requirements for chrome rods call for an average roughness Ra<0.2 μm. In reality, the roughness is much lower (Ra<0.1 μm) due to the grinding range used to close the chromium crazing, which would otherwise be a hydraulic leakage path. In addition, full scale tests with surface finishes above Ra 0.1 μm show wear on the rod seals 212, which may predict leakage problems in service.

The roughness of a surface is characterised by irregularities and comprises several parameters: the average roughness Ra, the average maximum peak height Rp and the maximum profile amplitude, Rz, over the measured length.

A specific study was therefore carried out with rods 21 which were manufactured with different levels of average roughness Ra: 0.04, 0.08 and 0.2. Tribological tests were carried out on these rods and gave the results illustrated in FIGS. 4 and 5.

It can be seen in FIG. 4 that a chrome-plated rod Tc with an average roughness Ra of approximately 0.05 μm results in average wear of less than 0.4%, while a first nickel alloy rod Ti1 with a roughness Ra of less than 0.1 μm results in average wear of less than 0.6% and a second nickel alloy rod Ti2 with a roughness close to Ra=0.2 μm results in average wear of more than 1.2%.

It is also noticed in FIG. 5 that the maximum height Rp has an influence on the average wear of the seal.

The surface of the different rods is visible in FIG. 6 with, from left to right, the surface of the chrome-plated rod Tc and then the two rods Ti1 and Ti2 before and after friction on the seal. The chrome-plated rod Tc shows wear ridges caused by repeated rubbing with the rod, whereas the nickel alloy rods, such as Inconel 718, do not show any, and are therefore able to withstand the wear caused by seal friction.

These tests made it possible to define minimum requirements to be specified in order to ensure performance: Ra max 0.2 μm.

1. A method for treating surface of a rod of a piston, the rod being made of a high-strength alloy with a minimum hardness greater than 45 HRC, the method comprising:
a grinding step, and
a finishing step until an average roughness Ra≤0.2 μm is obtained.

2. The surface treatment method according to claim 1, wherein the high-strength alloy is a nickel-based superalloy.

3. The surface treatment method according to claim 2, wherein the high-strength alloy has a tensile strength Rm>1100 MPa.

4. The surface treatment method according to claim 1, wherein the finishing step is tribofinishing.

5. A piston rod obtained by the surface treatment method according to claim 1.

6. A piston comprising a piston rod according to claim 5.

7. The piston according to claim 6, wherein the piston rod comprises a seal between a pressurised environment and a non-pressurised environment.

8. The piston according to claim 7, wherein the rod is disposed in a deformation tube and comprises a sphere at a first end cooperating with the deformation tube.

9. A braking system comprising at least one piston according to claim 7.
